(19) United States
(12) Patent Application Publication
(10) Pub. No.: US 2006/0099970 A1
(43) Pub. Date: May 11, 2006

(54) Method and system for providing a log of mobile station location requests

(76) Inventors: Scott D. Morgan, Lake in the Hills, IL (US); Eric J. Hefner, Gurnee, IL (US); Mary Hor-Lao, Vernon Hills, IL (US); Dale S. Neuzil, Lake Villa, IL (US); Sharada Raghuram, Buffalo Grove, IL (US); Michelle H. Xiong, Vernon Hills, IL (US)

Correspondence Address: MOTOROLA INC, 600 NORTH US HIGHWAY 45, ROOM AS437, LIBERTYVILLE, IL, 60048-5343, US

(21) Appl. No.: 10/985,791

(22) Filed: Nov. 10, 2004

(51) Int. Cl. H04B 1/00

(52) U.S. Cl. 455/456.6

(57) ABSTRACT

A method and system of providing a log of mobile station geographic location requests is useful for protecting the privacy of mobile station users. The method is performed on a mobile station and includes receiving in the mobile station a location request from a requestor, the location request seeking the geographic location of the mobile station. It is then determined whether the location request is a Mobile Terminated Location Request (MTLR), a Network Initiated Location Request (NILR), or a Mobile Originated Location Request (MOLR). Log information about the location request is then stored and it is determined whether the mobile station has local privacy settings that apply uniquely to the requestor. The location request is then responded to in accordance with local privacy settings, and log information about the response to the location request is stored.

### FIELD OF THE INVENTION

The present invention relates generally to a method and system for monitoring access to information concerning the geographic location of a mobile station, and in particular to logging location requests such that the requests may be reviewed by a mobile station user.

### BACKGROUND OF THE INVENTION

Mobile phones increasingly include a locating feature that enable the geographic location of the mobile phones to be either displayed on the phones or transmitted to a remote receiver. These features are generally called location services (abbreviated as LCS, for “LoCation Services”). LCS features that display location coordinates on a phone are useful, for example, to phone users who need to know where they are located relative to geographic map coordinates. Thus LCS features can enable a mobile phone user to initiate a location request where the phone acts as a Global Positioning System (GPS) terminal. Also, location requests may be initiated by third parties and transmitted to a phone over a wireless network. Such third party requests are useful in various circumstances. For example mobile phone networks may be able to improve network efficiency and provide better Quality of Service (QoS) and roaming rates to a mobile user if the network can periodically monitor a mobile phone location. Also, emergency services can save lives by more rapidly and accurately identifying where emergency phone calls have originated. Further, some parents may seek to supervise for example their teenage children using the ability to learn their children's precise location through a mobile phone locator.

The increased use of mobile phone locating technology is often convenient and helpful, but sometimes it also raises difficult privacy issues. As with many technological developments, advantages of mobile phone locating technology can be used for many nefarious purposes. For example many mobile phone users may object to the possibility of anonymous network operators having the ability to track the users' every movement. Further many teenagers may not object to their parents being able to monitor the teenagers' locations in some circumstances, but may seek to negotiate conditions about when and how their locations can be learned.

Therefore numerous privacy protection features associated with LCS are either in use or have been suggested. Such privacy features include simple privacy flags that can be set to turn LCS features on and off. For example a mobile phone user can simply toggle an LCS privacy switch on his or her phone using an interface such as the phone display screen. If the LCS privacy switch is turned on, then the phone will prevent any location information from being transmitted from the phone. Such “all or nothing” switches are often undesirable, however, because users frequently can benefit from having greater control over LCS transmissions. For example a user may desire to prevent selected people from learning the location of a phone, but may still want a network operator to be able to locate the phone so as to optimize QoS and roaming rates.

LCS privacy engines have thus been suggested, which engines are resident on a mobile phone and provide significant flexibility to a phone user concerning LCS features such as rules specifying unrestricted access to location information; rules specifying access contingent on user notification and required approvals; rules specifying access with user notification but without required approvals; rules specifying access denial during user-selected time periods; and rules specifying access for only defined approximations of locations.

However, to further enhance the privacy and convenience of LCS features on mobile phones, improved methods and systems are required that provide to users additional control over LCS features.

### SUMMARY OF THE INVENTION

Therefore, according to one form, the present invention is a method of providing a log of mobile station geographic location requests. The method is performed on a mobile station such as a mobile phone, and includes receiving in the mobile station a location request from a requestor, which location request seeks the geographic location of the mobile station. It is then determined whether the location request is a Mobile Terminated Location Request (MTLR), a Network Initiated Location Request (NILR), or a Mobile Originated Location Request (MOLR). Log information about the location request is then stored and it is determined whether the mobile station has local privacy settings that apply uniquely to the requestor. The location request is then responded to in accordance with local privacy settings, and log information about the response to the location request is stored.

According to another form, the invention is a system, incorporated in a mobile station, which performs the above described method.

### BRIEF DESCRIPTION OF THE DRAWINGS

In order that the invention may be readily understood and put into practical effect, reference will now be made to a preferred embodiment as illustrated with reference to the accompanying drawings, wherein like reference numbers refer to like elements, in which:

FIG. 1 is a schematic diagram illustrating a radio communications device in the form of a mobile telephone;

FIG. 2 is a schematic diagram illustrating a menu screen showing a location request history listing that includes a short identification of individual requestors and classes of requestors according to an embodiment of the present invention;

FIG. 3 is a schematic diagram illustrating a menu screen showing further details of log information that may be displayed, according to an embodiment of the present invention, when a user selects an individual requestor from the list shown in FIG. 2;

FIG. 4 is a schematic diagram illustrating a menu screen showing local privacy settings established for an individual requester according to an embodiment of the present invention;

FIG. 5 is a flow diagram illustrating the processing steps within a mobile phone concerning location requests designated as MTLR according to an embodiment of the present invention;

FIG. 6 is a flow diagram illustrating the processing steps within a mobile phone concerning location requests designated as NILR according to an embodiment of the present invention;

FIG. 7 is a flow diagram illustrating the processing steps within a mobile phone concerning location requests designated as MOLR according to an embodiment of the present invention; and

FIG. 8 is a flow diagram illustrating general steps for providing a log of mobile station location requests according to an embodiment of the present invention.

### DETAILED DESCRIPTION OF THE DRAWINGS

The present invention, according to a preferred embodiment, advantageously overcomes problems with the prior art by providing a method, system and computer program for providing a log of mobile station geographic location requests, as will be discussed in detail below.

The instant disclosure is provided to further explain in an enabling fashion the best modes of making and using various embodiments in accordance with the present invention. The disclosure is further offered to enhance an understanding and appreciation for the inventive principles and advantages thereof, rather than to limit in any manner the invention.

It is further understood that the use of relational terms are used solely to distinguish one from another entity or action without necessarily requiring or implying any actual such relationship or order between such entities or actions.

Much of the inventive functionality and many of the inventive principles are best implemented with or in software programs or instructions and integrated circuits (ICs) such as application specific ICs. It is expected that one of ordinary skill when guided by the concepts and principles disclosed herein will be readily capable of generating such software instructions and programs and ICs with minimal experimentation. Therefore, in the interest of brevity and minimization of any risk of obscuring the principles and concepts according to the present invention, further discussion of such software and ICs will be limited to the essentials with respect to the principles and concepts used by the preferred embodiments.

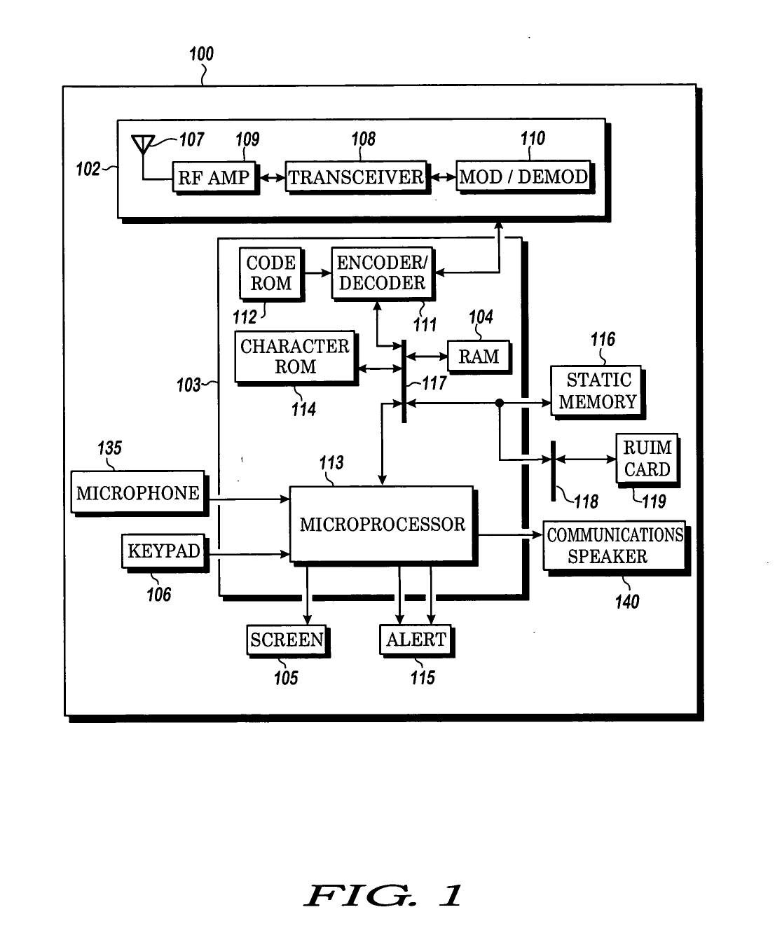

Referring to FIG. 1, there is a schematic diagram illustrating a radio communications device in the form of a mobile station or mobile telephone 100 comprising a radio frequency communications unit 102 coupled to be in communication with a processor 103. The mobile telephone 100 also has a keypad 106 and a display screen 105 coupled to be in communication with the processor 103. As will be apparent to a person skilled in the art, screen 105 may be a touch screen thereby making the keypad 106 optional.

The processor 103 includes an encoder/decoder 111 with an associated code Read Only Memory (ROM) 112 for storing data for encoding and decoding voice or other signals that may be transmitted or received by the mobile telephone 100. The processor 103 also includes a micro-processor 113 coupled, by a common data and address bus 117, to the encoder/decoder 111, a character Read Only Memory (ROM) 114, a Random Access Memory (RAM) 104, static programmable memory 116 and a Removable User Identity Module (RUIM) interface 118. The static programmable memory 116 and a RUIM card 119 operatively coupled to the RUIM interface 118 each can store, amongst other things, Preferred Roaming Lists (PRLs), subscriber authentication data, selected incoming text messages and a Telephone Number Database (TND phonebook) comprising a number field for telephone numbers and a name field for identifiers associated with one of the numbers in the name field. For instance, one entry in the Telephone Number Database may be 91999111111 (entered in the number field) with an associated identifier “Steven C! at work” in the name field. The RUIM card 119 and static memory 116 may also store passwords for allowing accessibility to password protected functions on the mobile telephone 100.

The micro-processor 113 has ports for coupling to the keypad 106, screen 105 and an alert 115 that typically contains an alert speaker, vibrator motor and associated drivers. Also, micro-processor 113 has ports for coupling to a microphone 135 and communications speaker 140. The character Read only memory 114 stores code for decoding or encoding text messages that may be received by the communications unit 102. In this embodiment the character Read Only Memory 114, RUIM card 119, and static memory 116 may also store Operating Code (OC) for the micro-processor 113 and code for performing functions associated with the mobile telephone 100.

The radio frequency communications unit 102 is a combined receiver and transmitter having a common antenna 107. The communications unit 102 has a transceiver 108 coupled to the antenna 107 via a radio frequency amplifier 109. The transceiver 108 is also coupled to a combined modulator/demodulator 110 that couples the communications unit 102 to the processor 103.

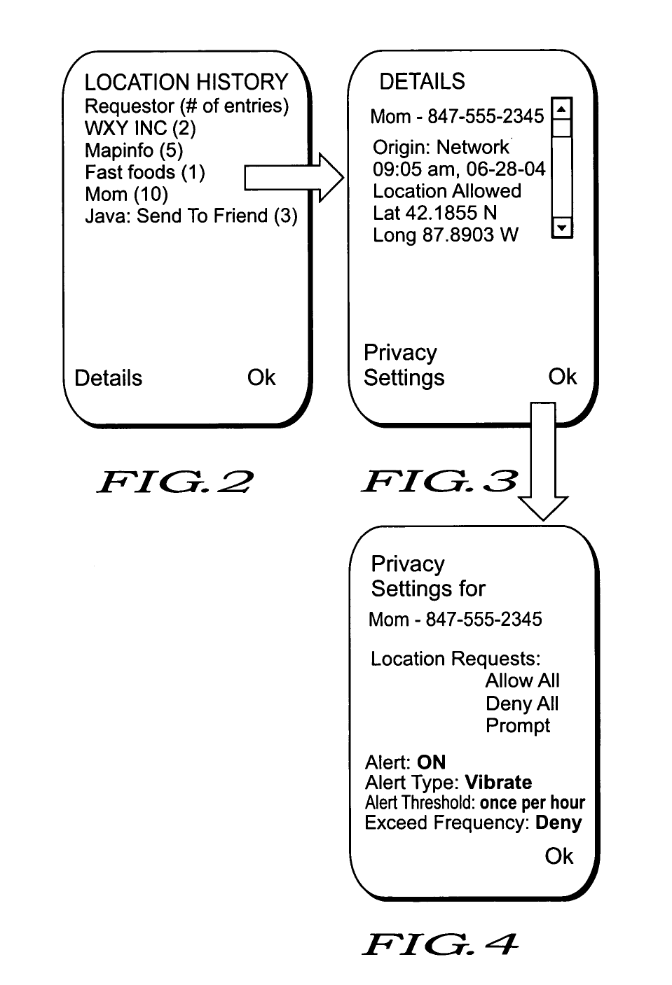

Referring to FIGS. 2-4 there are schematic diagrams illustrating nested menu screens that may be depicted on the display 105 of a mobile phone 100. The information displayed in the menus shown in FIGS. 2-4 is generally retrieved from a log of mobile station geographic location requests that is created according to a method of the present invention. Throughout this specification mobile phones 100 will be described as one example of a mobile station on which the present invention may be implemented. However those skilled in the art will appreciate that the present invention is applicable to many other types of mobile stations such as for example laptop computers and personal digital assistants (PDAs).

FIG. 2 illustrates a location request history listing that includes a short identification of individual requestors and classes of requesters, and respective numbers indicating the total number of location requests received from each individual requestor and class of requestor. Individual requestors are defined as any individual or entity that requests the geographic location of a specific mobile phone 100. Classes of requestors identify groups of entities that request the geographic location of a mobile phone 100. For example an individual requestor may include a corporate entity such as “WXY Inc.” or a person such as “Mom”. A class of requestor may include for example a group such as “customers”. Also, a location request history listing as shown in FIG. 2 may include a log of geographic location requests that were initiated by a user of the mobile phone 100 on which the location request history resides. For example the listing may include the entry “Java: SendToFriend (3)” that indicates that a log of mobile station location requests stored on the mobile phone 100 includes details about three separate transmissions of location information from the mobile phone 100 (Java is trademark or registered trademark of Sun Microsystems, Inc. in the United States and other countries).

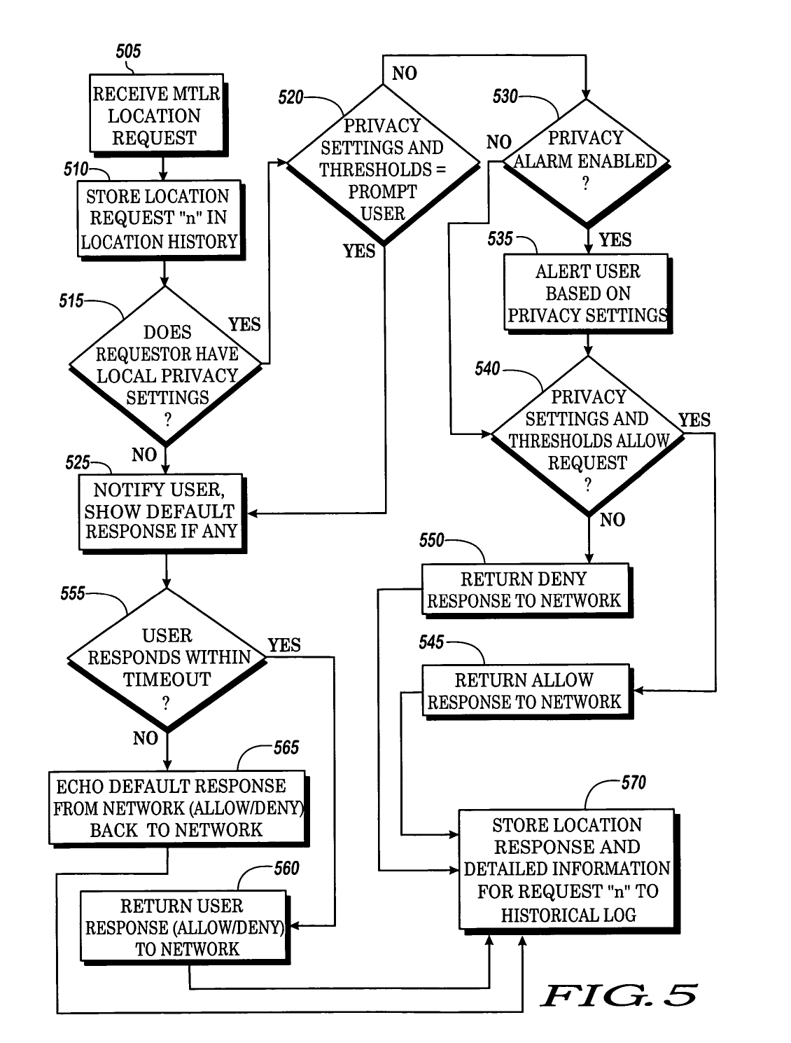

The entry “Mom (10)” shown in FIG. 2 indicates that a log of mobile station location requests stored on the mobile phone 100 includes details about ten geographic location requests received by the phone 100 from an individual identified as “Mom.” FIG. 3 provides an example of further details of log information that may be displayed when a user selects the entry “Mom (10)” shown in FIG. 2. The details may include a phone number of a requestor; the origin of a location request such as a network, another mobile station, or the local phone 100 itself; the time and date of the request; whether the request was allowed; and if allowed the specific geographic location that was transmitted to the requestor (such as specific latitude and longitude coordinates).

Whether a specific request is allowed depends on the particular privacy settings that a user has established for each individual requestor or class of requestor. FIG. 4 illustrates an example of local privacy settings established for the individual identified as “Mom.” The privacy settings may include alternative rules such as “allow all,” “deny all,” and “prompt.” The rule “allow all” means that all location requests received by the mobile phone 100 from that individual will be allowed, and thus the phone 100 will respond to such requests by transmitting to the requestor the geographic location of the phone 100. The rule “deny all” means that all location requests received by the mobile phone 100 from a specific requestor will not be allowed, and thus the phone 100 will respond to such requests by transmitting a response indicating that the requests were denied. The rule “prompt” means that a user of the phone 100 will be first prompted to allow or deny a location request received from a particular requestor before a response is transmitted.

The variable “Alert: ON” shown in FIG. 4 means that a user seeks to be alerted if the location requests from a particular requestor exceed a particular threshold. For example thresholds may be set to issue an alert if more than a specified number of location requests from a particular requestor are received in a specified time period. The variable “Alert Type: Vibrate” shown in FIG. 4 means that a users seeks to have the phone 100 vibrate when an alert is triggered. Other means of indicating alerts include visual displays on the screen 105, playing music, speech, or other sounds over the speaker 140, or using other devices operatively connected to the alert 115. Accordingly the variable “Alert Threshold: once per hour” shown in FIG. 4 means that an alert will be triggered if the requestor “Mom” requests the geographic location of the phone 100 more than once per hour. Finally, the variable “Exceed Frequency: Deny” means that all requests that exceed the alert threshold will be automatically denied.

The menus shown in FIGS. 2-4 are merely examples of the types of graphical interfaces that may be used according to the present invention to communicate to a user both data from a log of received mobile station location requests, and data concerning local privacy settings. Those skilled in the art will appreciate that numerous other designs and formats for communicating such data are within the scope of the present invention.

The log of mobile station location requests provided by the present invention is useful for recording the origin of location requests. That information can be very helpful to mobile phone users who seek to protect their privacy. Location requests received by a mobile phone 100 generally can be categorized as one of three types. First, Mobile Terminated Location Requests (MTLRs) are location requests that are initiated by another network user, including other mobile stations, websites or information services. Second, Network Initiated Location Requests (NILRs) are location requests that are received from a mobile network where the network is not requesting verification or notification. Typically NILRs are used for locating mobile stations for emergency or law-enforcement purposes. Third, Mobile Originated Location Requests (MOLR) are location requests that originate from within a mobile station itself. If phone users are provided convenient access to a log that includes the origin of location requests, the users are able to better understand how location information about their phones 100 is being used and thus better manage their own privacy. Furthermore, the ability of the phone privacy features of the present invention to log and display the origin of all location requests can be a useful tool for enabling phone users to better manage their own privacy.

Referring to FIGS. 5-7, there are flow diagrams illustrating the processing steps within a mobile phone 100 concerning location requests that are either MTLRs, NILRs, or MOLRs, respectively. Each of FIGS. 5-7 is described in more detail below.

FIG. 5 illustrates a method 500 of the processing steps within a mobile phone 100 concerning location requests designated as MTLR. First, at step 505 a MTLR location request is received by the mobile phone 100. Next, at step 510 the request is stored sequentially in a location history file. At step 515 it is determined whether the mobile phone 100 has local privacy settings that apply uniquely to the requester. For example, referring back to FIG. 4, a location request from telephone number 847-555-2345, designated as “Mom,” includes the local privacy settings shown in FIG. 4 that apply uniquely to “Mom.”

If it is determined at step 515 that local privacy settings that apply uniquely to the requestor exist, then the method 500 continues to step 520 where it is determined whether the local privacy settings and corresponding thresholds require the phone user to be prompted. If so then the method 500 continues at step 525 where the user is prompted or notified. Otherwise the method 500 continues at step 530 where it is determined whether a privacy alarm is enabled.

A privacy alarm is a privacy feature separate from requestor-specific privacy settings. Privacy alarms may be designed to allow a user to review or automatically deny all location requests either, for example, during specific time periods or when the user is in particular regions or locations.

If at step 530 it is determined that a privacy alarm is enabled then at step 535 a user is alerted based on the privacy settings. Otherwise, if a privacy alarm is not enabled, or following an alert to the user, the method 500 continues at step 540 where it is determined whether the local privacy settings and thresholds allow the request. If so then the method 500 continues at step 545 where an allow response including geographic coordinates is returned to the network and then to the requestor. If the request is denied then at step 550 a deny response is returned to the network and then to the requestor.

Returning to step 515, if local privacy settings do not exist for a requester, or if at step 520 it is determined that the local privacy settings and thresholds require the user to be prompted, then the method 500 continues at step 525 where the user is prompted or notified and shown any default response that may have been generated. Next, at step 555 it is determined whether the user responded to the prompt given at step 525 within a defined timeout period. If so then at step 560 the user's response to allow or deny the request is returned to the network. Otherwise a default response to allow or deny the request is echoed back to the network at step 565.

Steps 555, 560 and 565 are further explained as follows regarding one specific embodiment of the present invention. According to the 3rd Generation Partnership Project (3GPP), privacy provisioning for MTLR location requests is held in the network. Settings can be configured in the network on a per-client basis to notify the user, ask for user verification, and configure a default response for use when a user does not respond. The default response will be echoed back to the network if the mobile station times out, or will be directly used by the network if the network times out first. The default response is also delivered to the mobile station so that the user is aware of the result if the user fails to respond. Ironically, according to the prior art a user would need to view the MTLR notification to know what occurs when no response is given; but, if the user is present to view the notification, then he or she most likely would respond to the MTLR anyway. However, according to the present invention, the log of received mobile station location requests records the default response for later viewing by a user.

Finally, following the responses provided to the network at steps, 545, 550, 560 and 565, the method 500 is completed at step 570 where details concerning the response to the MTLR are stored in a historical log. Those skilled in the art will appreciate that the log may be stored in various locations such as in a static programmable memory 116, a Removable User Identity Module (RUIM), or separate from the phone on a network. Details of the responses stored in the log are described above and generally include the items shown in FIG. 3 and include whether each request is a MTLR, NILR or MOLR.

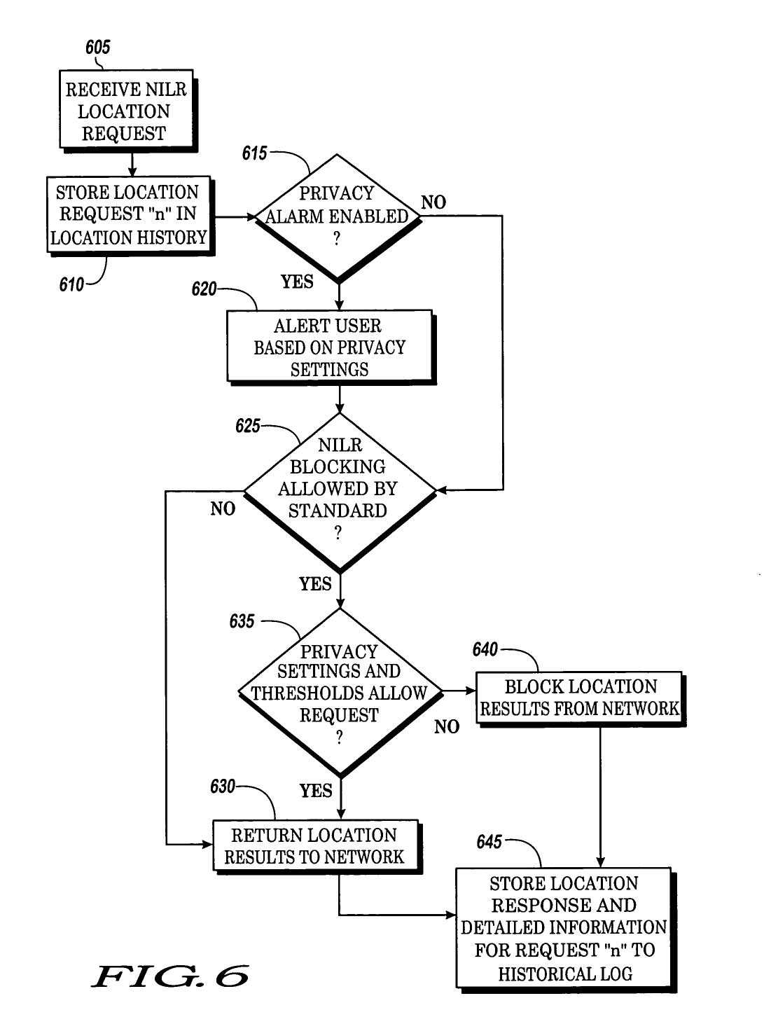

FIG. 6 illustrates a method 600 of the processing steps within a mobile phone 100 concerning location requests designated as NILR. First, at step 605 a NILR location request is received by the mobile phone 100. Next, at sep 610 the request is stored sequentially in a location history file. At step 615 it is then determined whether a privacy alarm is enabled. If so, then at step 620 the user is alerted based on corresponding privacy settings. After the user is alerted, or if no privacy alarm is enabled, then at step 625 it is determined whether NILR blocking is allowed by applicable standards. If applicable standards do not allow blocking of NILRs, then the method 600 proceeds to step 630 where location results are returned to the network.

If at step 625 it is determined that applicable standards allow blocking of NILRs, then at step 635 it is determined whether privacy settings and thresholds allow the request. If so at step 630 the location results are returned to the network. If not, at step 640 a response is transmitted to the network stating that the location results are blocked. Finally, following the responses provided to the network at steps, 630 and 640, the method 600 is completed at step 645 where details concerning the response to the NILR are stored in the historical log.

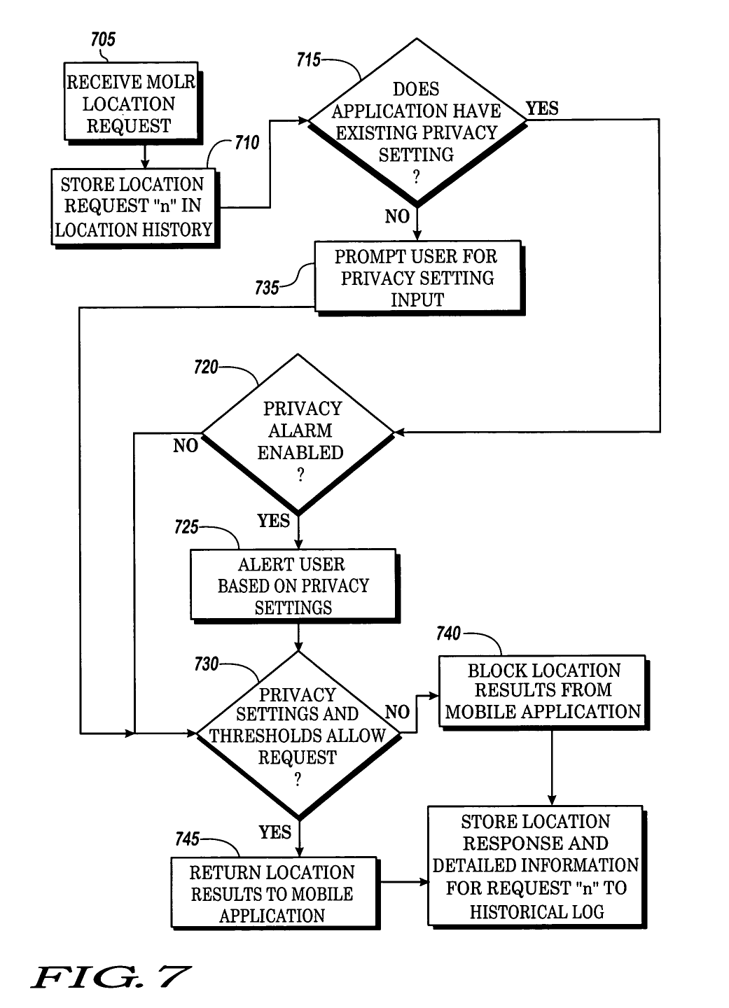

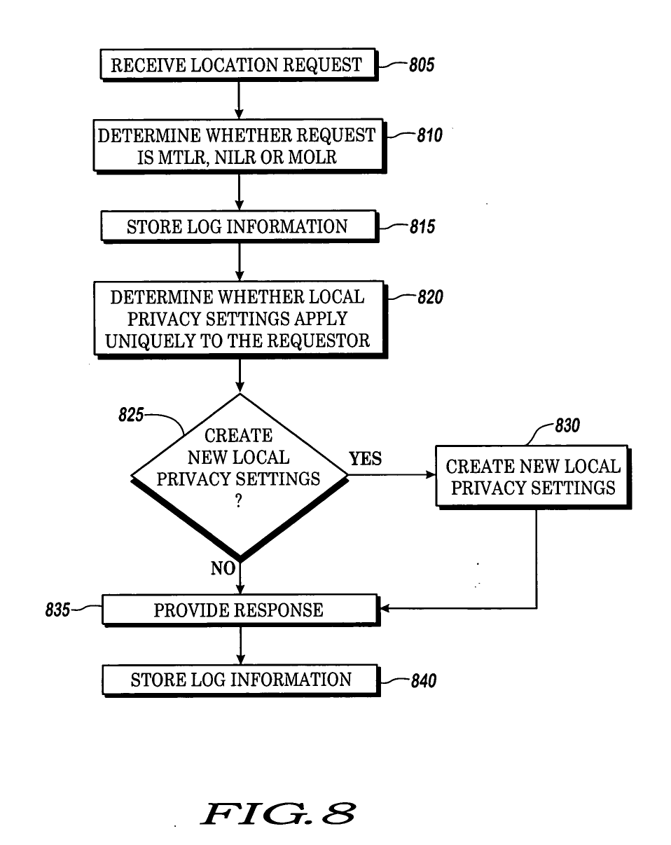

FIG. 7 illustrates a method 700 of the processing steps within a mobile phone 100 concerning location requests designated as MOLR. First, at step 705 a MOLR location request is received by the mobile phone 100. Next, at sep 710 the request is stored sequentially in a location history file. At step 715 it is then determined whether the application that initiated the MOLR—which application is resident on the mobile phone 100—has an existing privacy setting. If so, then at step 720 it is determined whether privacy alarms are enabled. If privacy alarms are enabled, then at step 725 an alert is sent to the user based on the privacy settings; otherwise the method 700 continues at step 730 where it is determined whether the relevant privacy settings and thresholds allow the request. Similarly, if at step 715 it is determined that privacy settings do not exist for the application that initiated the MOLR, then at step 735 the user is prompted to enter privacy settings for the application that initiated the MOLR. Then at step 730 it is determined whether such privacy settings and thresholds allow the request.

If at step 730 the privacy settings and thresholds do not allow the request, then the method 700 continues at step 740 where the application that initiated the MOLR is blocked from receiving the location of the mobile phone 100. Otherwise the location of the mobile phone 100 is returned to the application. Finally, following steps 740 and 745, the method 700 is completed at step 750 where details concerning the response to the MOLR are stored in the historical log.

Referring to FIG. 8, there is a flow diagram illustrating the general steps of a method 800 for providing a log of mobile station location requests according to an embodiment of the present invention. First, at step 805 a location request is received in a mobile station. Next, at step 810 it is determined whether the request is a MTLR, NILR or MOLR. Then at step 815 log information about the request is stored. At step 820 it is then determined whether local privacy settings apply uniquely to the requestor. Then at step 825 it is determined whether new local privacy settings should be created that apply uniquely to the requestor. If so, then at step 830 the new local privacy settings are created. Next, at step 835 a response is provided to the location request in accordance with local privacy settings. Finally, at step 840 log information about the response to the location request is stored.

Those skilled in the art will appreciate that the present invention can be implemented on mobile stations that use various types of locating technologies to provide LCS features. Examples of such locating technologies include the Global Positioning System (GPS), assisted GPS, Observed Time Difference; Enhanced Forward Link Triangulation, Time of Arrival, Time Difference of Arrival, Angle of Arrival, Multipath Fingerprinting, Timing Advance, Enhanced Observed Time Difference, or hybrid geolocation technologies.

The present invention therefore provides to mobile station users significantly more control over LCS features. Such added control means that users are able to better protect their privacy, particularly through the ability to monitor MOLRs, and users are able to more conveniently exploit the advantages of LCS features.

The terms “a” or “an”, as used herein, are defined as one or more than one. The terms including and/or having, as used herein, are defined as comprising (i.e., open language). The term operatively connected, as used herein, is defined as connected but not necessarily directly, and not necessarily mechanically. The term computer program as used herein is defined as a sequence of instructions designed for execution on a microprocessor. A program, computer program, or software application may include a subroutine, a function, a procedure, an object method, an object implementation, an executable application, an applet, a servlet, a source code, an object code, a shared library/dynamic load library and/or other sequence of instructions designed for execution on a microprocessor.

The above detailed description provides a preferred exemplary embodiment only, and is not intended to limit the scope, applicability, or configuration of the present invention. Rather, the detailed description of the preferred exemplary embodiment provides those skilled in the art with an enabling description for implementing the preferred exemplary embodiment of the invention. It should be understood that various changes can be made in the function and arrangement of elements and steps without departing from the spirit and scope of the invention as set forth in the appended claims.

We claim:

1. A method of providing a log of mobile station geographic location requests, the method being performed on a mobile station, comprising the steps of:
receiving in the mobile station a location request from a requestor, the location request seeking the geographic location of the mobile station;
determining whether the location request is a Mobile Terminated Location Request (MTLR), a Network Initiated Location Request (NILR), or a Mobile Originated Location Request (MOLR);
storing log information about the location request;
determining whether the mobile station has local privacy settings that apply uniquely to the requester;
responding to the location request in accordance with local privacy settings; and
storing log information about the response to the location request.

2. The method according to claim 1, wherein the log information about the location request includes whether the location request is a Mobile Terminated Location Request (MTLR), a Network Initiated Location Request (NILR), or a Mobile Originated Location Request (MOLR)

3. The method according to claim 1, further comprising the step of creating new local privacy settings that apply uniquely to the requestor.

4. The method according to claim 1, wherein the local privacy settings include a frequency limit, where an alert is issued if more than a specified number of a particular type of location request is received in a specified time period.

5. The method according to claim 1, wherein the log of mobile station location requests includes a location request history listing including individual requestors and classes of requestors, and respective numbers indicating the total number of location requests received from each individual requestor and class of requestor.

6. The method according to claim 1, wherein the log of mobile station location requests includes for each request at least one of the following: a) identification information concerning the requester or class of requester; b) the time the request was received; c) whether the request was allowed; and d) if the request was allowed, the coordinates transmitted to the requestor.

7. The method according to claim 1, wherein local privacy settings that apply to the requestor include an alarm that is to be triggered based on at least one of the following: a) an identity of a requestor; b) a requested Quality of Service; c) a request frequency; and d) a time of a request.

8. The method according to claim 1, wherein a response to the location request includes the location of the mobile station obtained using the Global Positioning System (GPS), assisted GPS, Observed Time Difference, Enhanced Forward Link Triangulation, Time of Arrival, Time Difference of Arrival, Angle of Arrival, Multipath Fingerprinting, Timing Advance, Enhanced Observed Time Difference, or a hybrid geolocation technology.

9. The method according to claim 1, further comprising the step of determining whether a privacy alarm is enabled.

10. The method according to claim 1, wherein different local privacy settings can be set for the mobile station depending on whether the location request is a MTLR, NILR or MOLR.

11. The method according to claim 1, further comprising the step of displaying on the mobile station a request history listing that includes a short identification of individual requesters and classes of requestors, and respective numbers indicating a total number of location requests received from each individual requestor and class of requester.

12. A system in a mobile station for providing a log of geographic location requests received by the mobile station, the system comprising:
a microprocessor; and
a memory operatively connected to the microprocessor;
wherein the memory includes computer readable code for causing the microprocessor to:
receive in the mobile station a location request from a requester, the location request seeking the geographic location of the mobile station;
determine whether the location request is a Mobile Terminated Location Request (MTLR), a Network Initiated Location Request (NILR), or a Mobile Originated Location Request (MOLR);
store log information about the location request;
determine whether the mobile station has local privacy settings that apply uniquely to the requestor;
respond to the location request in accordance with local privacy settings; and
store log information about the response to the location request.

13. The system according to claim 12, wherein the log information about the location request includes whether the location request is a Mobile Terminated Location Request (MTLR), a Network Initiated Location Request (NILR), or a Mobile Originated Location Request (MOLR)

14. The system according to claim 12, wherein the computer readable code further causes the microprocessor to create new local privacy settings that apply uniquely to the requestor.

15. The system according to claim 12, wherein the local privacy settings include a frequency limit, where an alert is issued if more than a specified number of a particular type of location request is received in a specified time period.

16. The system according to claim 12, wherein the log of mobile station location requests includes a location request history listing including individual requesters and classes of requesters, and respective numbers indicating the total number of location requests received from each individual requestor and class of requestor.

17. The system according to claim 12, wherein the log of mobile station location requests includes for each request at least one of the following: a) identification information concerning the requester or class of requestor; b) the time the request was received; c) whether the request was allowed; and d) if the request was allowed, the coordinates transmitted to the requester.

18. The system according to claim 12, wherein local privacy settings that apply to the requester include an alarm that is to be triggered based on at least one of the following: a) an identity of a requestor; b) a requested Quality of Service; c) a request frequency; and d) a time of a request.

19. The system according to claim 12, wherein a response to the location request includes the location of the mobile station obtained using the Global Positioning System (GPS), assisted GPS, Observed Time Difference, Enhanced Forward Link Triangulation, Time of Arrival, Time Difference of Arrival, Angle of Arrival, Multipath Fingerprinting, Timing Advance, Enhanced Observed Time Difference, or a hybrid geolocation technology.

20. The system according to claim 12, wherein the computer readable code further causes the microprocessor to determine whether a privacy alarm is enabled.

21. The system according to claim 12, further comprising a display operatively connected to the microprocessor, and wherein the computer readable code further causes the microprocessor to list on the display a request history listing that includes a short identification of individual requestors and classes of requestors, and respective numbers indicating a total number of location requests received from each individual requestor and class of requestor.

22. A system of providing a log of mobile station geographic location requests comprising:
means for receiving in the mobile station a location request from a requestor, the location request seeking the geographic location of the mobile station;
means for determining whether the location request is a Mobile Terminated Location Request (MTLR), a Network Initiated Location Request (NILR), or a Mobile Originated Location Request (MOLR);
means for storing log information about the location request;
means for determining whether the mobile station has local privacy settings that apply uniquely to the requestor;
means for responding to the location request in accordance with local privacy settings; and
means for storing log information about the response to the location request.
